(19) United States
(12) Patent Application Publication
(10) Pub. No.: US 2024/0316565 A1
(43) Pub. Date: Sep. 26, 2024

(54) GREYBOARD RACK FOR SAMPLE TUBE PREPARATION, TRANSFER, PROCESSING, AND STORAGE

(71) Applicant: Scilutions, LLC, Oakwood, OH (US)

(72) Inventors: Tso Hua Chao, San Jose, CA (US); Robin Tan, San Mateo, CA (US); Chad Jenkins, Santa Cruz, CA (US); Sonia Kritz, Berkeley, CA (US)

(21) Appl. No.: 18/587,027

(22) Filed: Feb. 26, 2024

Related U.S. Application Data
(60) Provisional application No. 63/448,064, filed on Feb. 24, 2023.

(51) Int. Cl. B01L 9/06; B31B 50/20; B31B 50/81; B31B 110/35; B31B 120/10; B65D 5/49; B65D 5/50; B65D 5/64

(52) U.S. Cl. CPC B01L 9/06; B31B 50/20; B31B 50/81; B65D 5/48032; B65D 5/5059; B65D 5/64; B01L 2200/025; B01L 2200/12; B01L 2300/0609; B01L 2300/0809; B01L 2300/12; B31B 2110/35; B31B 2120/10

(57) ABSTRACT

A rack for sample tubes, the rack comprising a box lid and a box frame; at least one tube holder layer that has a matrix of open-ended apertures for receiving the sample tubes, wherein the at least one tube holder layer is constructed from a corrugated material; and a tube locking layer that has a matrix of open-ended apertures, aligned with the matrix of open-ended apertures of the at least one tube holder layer, which each include one or more projections extending into the aperture for locking received sample tubes against rotation relative to the tube locking layer; wherein the tube locking layer is positioned between the at least one tube holder layer and the bottom of the box frame.

### TECHNICAL FIELD

The present disclosure generally relates to carriers; accessories for analytical sciences; and, in particular, to sample tube racks used for the preparation, transfer, processing, and storage of large numbers of small volume samples in analytical chemistry applications such as Polymerase Chain Reaction (PCR) analysis.

### RELATED APPLICATIONS

This application claims priority to U.S. Provisional Patent Application No. 63/448,064 filed Feb. 24, 2023, and incorporates the same by reference.

### BACKGROUND

“Microtube” racks are frequently used in laboratories to prepare, transfer, access, process, and store milliliter- or sub-milliliter-volume samples during the performance of high throughput manual, semi-automated, or highly automated analytical chemistry applications such as PCR analysis. The racks provide a two dimensional matrix of open “wells” which receive and position sample tubes, generally described as microtubes, for use with multichannel pipettes, automatic robotic transfer and analysis systems, and, at a more macro-level, automated robotic transfer and sample storage systems. Such racks are typically manufactured to conform to a standard footprint such as the ANSI/SBS 1-2004 standard for 96-well microplates, and are generally made from injection-molded thermoplastic polymers such as polypropylene. Such racks are also generally manufactured to hold a specific size of microtube, where sample tubes ranging from 0.2 mL to 2.0 mL in volume (including, but not limited to, 0.2 mL, 0.5 mL, 1.5 mL, and 2.0 mL tubes) may be required to support a particular analytical chemistry application or customer requirement. As a result of such racks being made from injection-molded thermoplastic polymers, the walls of each individual well are sheathed and thus highly insulating.

### SUMMARY OF INVENTION

The present application discloses a novel rack for sample tube preparation, transfer, processing, and storage. A rack may be manufactured from recycled paper and cardboard materials including paper or cardboard resin, and, significantly, may itself be recycled within conventional paper, cardboard, and packaging recycling streams, avoiding the issues of bottle- or tub-format container restrictions and low recycling rates typically found in plastics recycling programs. The manufacturing process for and dimensions of the rack may also be readily adapted to work with varying rack footprints and, in particular, various microtube volume sizes and layouts, through simple changes to select cutting and assembly operations rather than through the purchase or manufacture of new injection molding dies. The physical construction of the rack may also feature layering or stacking so to increase the rack's strength, durability, and rigidity during use as well as transfer. Also, by stacking in a way as described herein—whereby the layers are honeycombed so as to avoid the “sheathed” effect of prior art racks—the rack increases the speed at which specimens that are stored in the rack are heated or cooled. This enhances sample viability in the specimens which are tested while stored in the rack. The devices, structures, manufacturing processes described herein permit racks of varying sizes (relating to the rack itself, as well as the number of and volume of sample tubes capable of being contained therein) to be manufactured with significant improvements in sustainability and significant reductions in retooling time and cost.

An example rack for sample tubes comprises a box lid and a box frame each constructed from a cardboard or resin material, preferably greyboard. In alternative embodiments, the rack and its constituent parts may be constructed of a non-cardboard or non-resin material such as aluminum, plastic, wood, or a synthetic compound such as injection-molded thermoplastic polymers. The box frame may have an open bottom for the display of indicia included on the bottom of some types of sample tubes. The box frame houses at least one tube holder layer that has a matrix of open-ended apertures for receiving the sample tubes. The tube holder layer is constructed from a cardboard or a resin material, preferably corrugated cardboard. The box frame also houses a tube locking layer that has a matrix of open-ended apertures, aligned with the matrix of open-ended apertures of the at least one tube holder layer, which each include one or more projections extending into the aperture for locking received sample tubes against rotation relative to the tube locking layer. The tube locking layer is constructed from a cardboard, resin, or paperboard material, preferably greyboard or laminated grey paperboard. The tube locking layer is positioned between the at least one tube holder layer and the bottom of the box frame. In some constructions, a bottom spacer is positioned between the tube locking layer and the bottom of the box frame. In some of the same or other constructions, a top spacer is affixed to the interior of the box lid proximate the top of the box lid, and configured to seat against a top surface of the box frame. In some of the same or still other constructions, a flange is affixed to the exterior of the box frame, and configured to block seating of the box lid on the box frame beyond a predetermined depth. The bottom spacer, top spacer, and flange, where present, are each constructed from a cardboard or resin material, preferably greyboard.

An example process for manufacturing an example rack comprises cutting one or more blanks of cardboard material into a box lid template and a box frame template, a tube holder layer template, and a tube locking layer template, then folding and securing the box lid template and box frame template, respectively, to form the box lid and box frame, respectively. The process further comprises cutting the tube holder layer template and tube locking layer template, respectively, to form matrices of open-ended apertures that are configured to mutually align when the respective layers are positioned within the box frame. The process further comprises positioning the cut tube holder layer and the cut tube locking layer within the box frame, with the tube locking layer positioned between the tube holder layer and the bottom of the box frame. In some processes, the cutting step includes cutting a bottom spacer, and the positioning step includes positioning the bottom spacer between the tube locking layer and the bottom of the box frame. In the same or other processes, the cutting step includes cutting a top spacer, and an additional positioning step includes affixing the top spacer to the interior of the box lid proximate the top of the box lid, wherein the top spacer is positioned and configured to seat against a top surface of the box frame upon assembly of the box lid to the box frame. In the same or still other processes, the cutting step includes cutting an external flange, and an additional positioning step includes affixing the flange to the exterior of the box frame, wherein the flange is positioned and configured to block seating of the box lid on the box frame beyond a predetermined depth upon assembly of the box lid to the box frame.

### BRIEF DESCRIPTION OF THE DRAWINGS

The following detailed description references various aspects of an illustrative, exemplary construction of a rack for sample tube preparation, transfer, processing, and storage that is shown in the accompanying drawings. Those of skill in the art will appreciate that the features illustrated in the drawings may not be drawn to scale, that some of the drawings may not depict all of the components of a given apparatus or device, and that one or more illustrated features may be used alone or in combination with other illustrated features in various other embodiments, constructions, and variants as described below. Those of skill in the art will further appreciate that the features illustrated in the drawings are exemplary instances of features discussed in the detailed description and do not serve to limit the claims. In the drawings, like reference numerals refer to like features in the various views.

FIG. 1 is a perspective view of a first embodiment of an assembled rack.

FIG. 2 is a perspective view of the box frame of the rack shown in FIG. 1.

FIG. 3 is a perspective view of the box frame of the rack shown in FIG. 1 with an included bottom spacer.

FIG. 4 is a perspective view of the box frame of the rack shown in FIG. 1 with a tube locking layer positioned over the included bottom spacer.

FIG. 5 is a perspective view of the box frame of the rack shown in FIG. 1 with a tube holder layer positioned over the tube locking layer and included bottom spacer.

FIG. 6 is a perspective view of the box lid of the rack shown in FIG. 1.

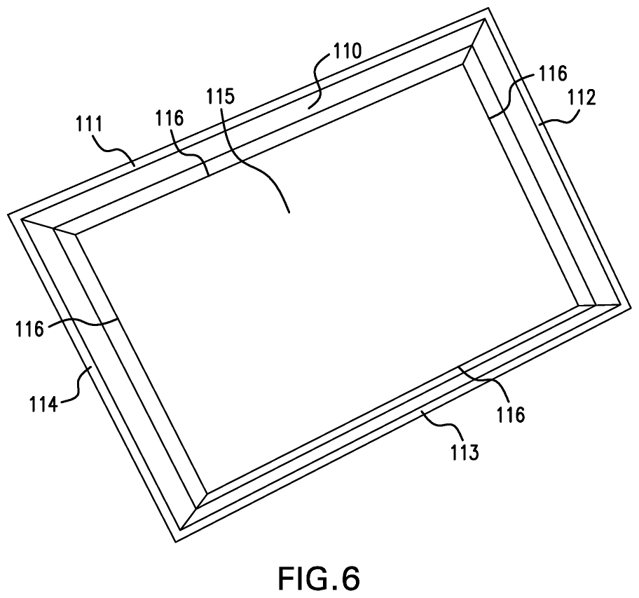

FIG. 7 is a perspective view of the box lid of the rack shown in FIG. 1 with an included top spacer.

FIG. 8 is a perspective view of a second embodiment of an assembled rack.

FIG. 9 is a schematic diagram of a process for manufacturing embodiments of the disclosed racks.

### DETAILED DESCRIPTION

While the description of the embodiments hereinbelow is with reference to a rack for sample tubes and sample tube preparation, transfer, processing, and storage, it will become evident to those skilled in the art that the embodiments of the invention are not limited thereto, but are also adaptable for other tube and tube-like items (whether hollow or solid, and including items having other, non-circular geometric cross-sections) to be disposed in racks, boxes, and multiple-unit containers.

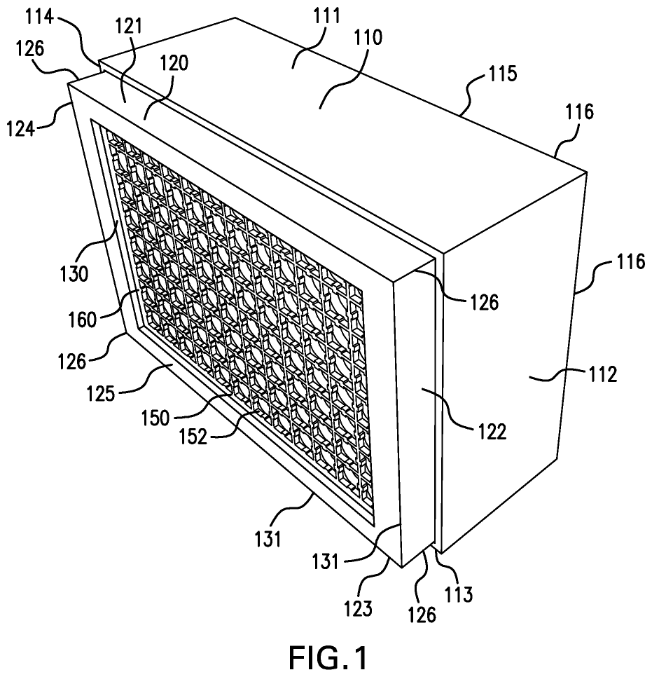

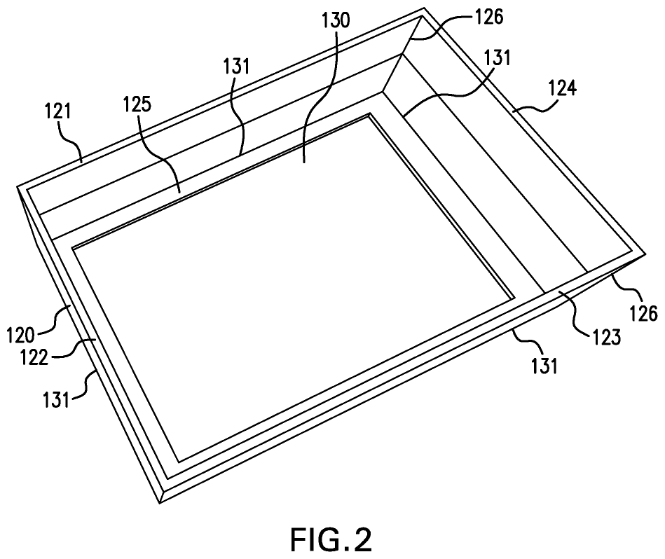

Referring initially to FIG. 1, an embodiment of a rack 100 comprises a box lid 110 and a box frame 120. The box lid 110 may be a five-sided, square or rectangular lid including sides 111-114 and top 115. The box lid 110 may be formed by cutting a blank and folding a resultant box lid template, such as along fold lines 116, to form the shape of the box lid. The box lid 110 may be secured in its folded shape via adhesives, inside and/or outside corner tapes (including, for example, paper, cellulose, or polymer-backed adhesive tapes with or without fiberglass or other reinforcement), laminated overwraps (including, for example, adhered paper, cellulose, or polymer film overwraps with or without fiberglass or other reinforcement), or combinations thereof. The box frame 120 may be a four or five-sided, square or rectangular frame including sides 121-124 and an optional box bottom panel 125. The box frame 120 may be formed by cutting a cardboard blank and folding a resultant box frame template, such as along fold lines 126, to form the shape of the box frame. The box frame 120 may have an open bottom for the display of indicia, such as two-dimensional bar codes, affixed to other otherwise included on the bottom of commercially available sample tubes. To that end, in some constructions the box frame template may be folded along fold lines 131 to form an inwardly projecting box bottom panel 125 having a central opening 130 (visible in FIG. 2). In other constructions, a separate box bottom panel 125 having a central opening 130 (visible in FIG. 2) may be affixed to the bottom of the box frame 120. The box frame 120 (and optional box bottom panel 125) may be secured in the folded or folded-and-assembled shape via adhesives, inside and/or outside corner tapes (including, for example, paper, cellulose, or polymer-backed adhesive tapes with or without fiberglass or other reinforcement), laminated overwraps (including, for example, adhered paper, cellulose, or polymer film overwraps with or without fiberglass or other reinforcement), or combinations thereof. The box lid 110 and box frame 120 are each constructed from a cardboard or resin material. Examples of such materials include laminated paperboard, non-corrugated cardboard, and corrugated cardboard, manufactured from virgin or recycled materials. In a preferred exemplary construction, the box lid 110 and box frame 120 are cut and formed from 1.9 mm thick greyboard or “unlined chipboard,” which is a cardboard made from recycled paper and cardboard materials that provides good strength and rigidity.

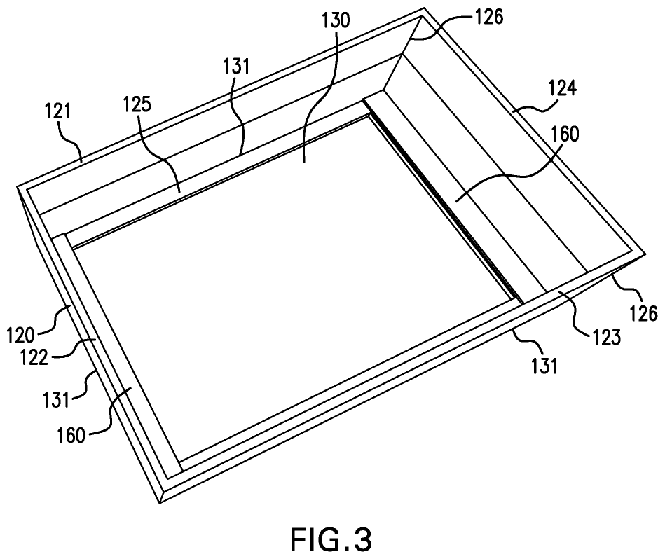

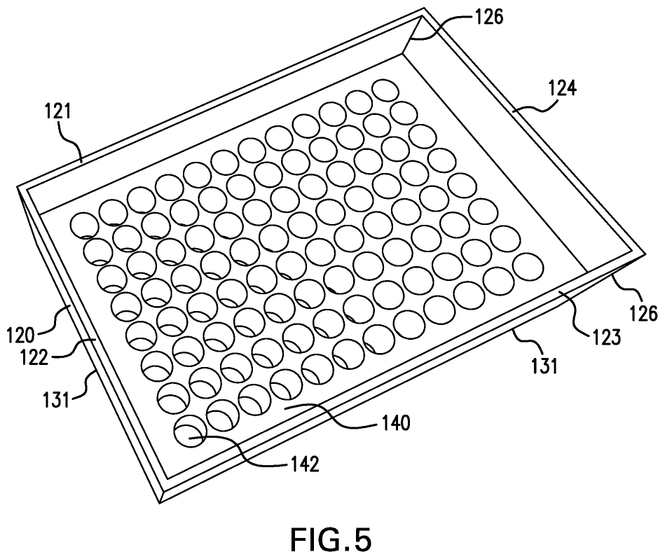

Turning to FIGS. 2-5, and in particular FIG. 5, the box frame 120 houses at least one tube holder layer 140 that has a matrix of open-ended apertures 142 for receiving sample tubes. The tube holder layer 140 may be formed by cutting a blank to form a template matching the interior footprint of the box frame 120 and cutting the plurality of open-ended apertures 142 in the cut tube holder layer. The cutting process may be accomplished by laser cutting techniques, or may alternatively be accomplished by manual techniques such as precision knife cutting, scissors, cleaving, or the like. Limitations in laser cutting processes may require that the tube holder layer 140 comprise a plurality of layers having separately cut open-ended apertures 142, wherein the plurality of layers are adhered or affixed to each other prior to or upon positioning within the box frame 120. However, a significant advantage of the laser cutting process is that the size, shape, number, and arrangement of the apertures in the matrix of open-ended apertures 142 may be changed simply by changing the programming of the laser cutter apparatus. In addition, the thickness of the tube holder layer 140 may be varied by changing the thickness and/or number of layers in the plurality of layers included therein. In embodiments, one or more tube holder layers 140 may be stacked. Stacking or layering of tube holder layers offers added, stability, strength and rigidity to the tube holder layer 140 that is otherwise absent from the prior art. This reduces the amount of movement sample tubes may experience while housed in the tube holder layer 140 during transport or other processes. Furthermore, depending on the material that is selected for construction of the tube holder layer, such as corrugated cardboard, the effect of stacked or layered tube holder layers is a lateral buttressing effect whereby the interior walls of the open-ended apertures 142 are not “smooth” or sheathed. The absence of a “smooth” or “sheathed” interior wall of the open-ended apertures increases the speed at which specimens that are stored in the rack are heated or cooled. By increasing the speed at which specimens may be heated or cooled, users enhance sample viability in the specimens which are tested while stored in the rack by avoiding latent deterioration during an otherwise elongated heating/cooling process. Furthermore, the durability and rigidity provide for a longer useful life for the rack and less inherent insulation against rapid heating or cooling of samples. The tube holder layer 140 may be constructed from a cardboard or resin material. Examples of such materials include laminated paperboard, non-corrugated cardboard, and corrugated cardboard, manufactured from virgin or recycled materials. In a preferred exemplary construction, the tube holder layer 140 is constructed from multiple layers of single wall corrugated cardboard, adhered or affixed to each other after laser cutting, so as to form a tube holder layer with a minimum thickness of 16 mm. This preferred embodiment provides the enhanced strength previously discussed without the need for additional layers (which take up space and necessitate additional materials). The lateral buttressing effect, which is derived by way of stacking one or more tube holder layers 140 also provides increased strength vertically if multiple racks are stacked on top of each other.

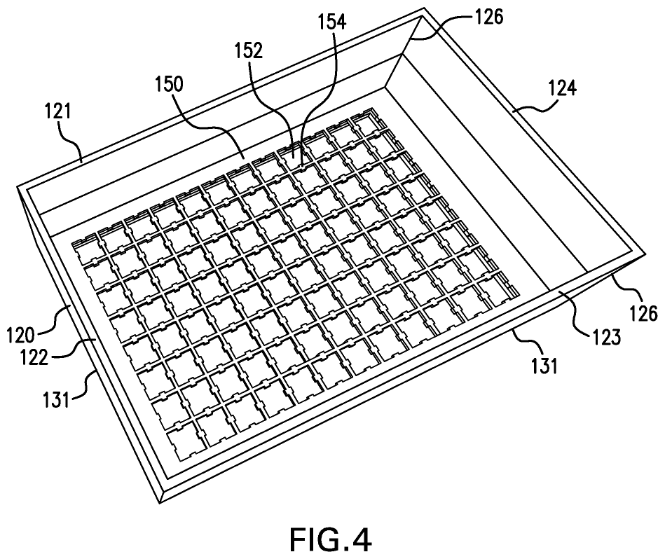

As shown in FIGS. 1 and 4, the box frame 120 also houses a tube locking layer 150 that has a matrix of open-ended apertures 152, aligned with the matrix of open-ended apertures 142 of the at least one tube holder layer 140, which each include one or more projections 154 extending into the aperture for locking received sample tubes against rotation relative to the tube locking layer. The tube locking layer 150 is positioned between the at least one tube holder layer 140 and the bottom of the box frame 120 (and, where present, the box bottom panel 125). The tube locking layer 150 may be formed by cutting a blank to form a template matching the interior footprint of the box frame 120 and cutting the plurality of open-ended apertures 152 and included projections 154 in the cut tube locking layer. The cutting process may be accomplished by laser cutting techniques, or may alternatively be accomplished by manual techniques such as precision knife cutting, scissors, cleaving, or the like. Again, a significant advantage of the laser cutting process is that the size, shape, number, and arrangement of the apertures in the matrix of open-ended apertures 152 may be changed simply by changing the programming of the laser cutter apparatus. In addition, the size, shape, number, and arrangement of the projections 154 may be changed simply by changing the programming of the laser cutter apparatus. The tube locking layer 150 is constructed from a cardboard or paperboard material. Examples of such materials include laminated paperboard, non-corrugated cardboard, and corrugated cardboard, manufactured from virgin or recycled materials. In a preferred exemplary construction, the tube locking layer 150 is constructed from three layers of 400 gsm paperboard adhered or affixed to each other so as to form a tube locking layer with a thickness of about 1.7 mm. The preferred exemplary construction has been found to maintain the integrity of the projections 154 for locking through multiple cycles of use.

Some embodiments and constructions of a rack 100 may include spacer elements for providing separation between the bottoms of the sample tubes and the bottom of the box frame 120 and/or the tops of the sample tubes and the top 115 of the box lid 110. As shown in FIGS. 1 and 3-4, in some embodiments, a bottom spacer 160 may be positioned between the tube locking layer 150 and the bottom of the box frame 120 (and, where present, the box bottom panel 125). In one construction, a bottom spacer 160 may, for example, comprise two strips of material affixed at opposite sides of the box frame 120 between the tube locking layer 150 and the bottom of the box frame, or affixed at opposite sides of the box frame 120 between the between the tube locking layer 150 and the box bottom panel 125. In alternate constructions, a bottom spacer 160 may comprise a plurality of inwardly projecting elements affixed to the inner surface of the box frame 120 or the box bottom panel 125. In other alternate constructions, the bottom spacer 160 may comprise a square or rectangular panel disposed between the tube locking layer 150 and the bottom of the box frame 120, or disposed between the between the tube locking layer 150 and the box bottom panel 125, and having a central opening 162, which may align with and be substantially coextensive with the central opening 130 of the box bottom panel 125 (where present). It will be appreciated that the bottom spacer(s) 160 may be affixed the interior of the sides 121-124 or bottom of the box frame 120, affixed to the interior of the box bottom panel 125 (i.e., to the top of the box bottom panel 125 itself or to the sides of the central opening 130 thereof), affixed to the tube locking layer 150, or captured between one or more of the sides 121-124 or bottom of the box frame 120, the interior of the box bottom panel 125, and the tube locking layer 150 in the assembled rack 100. The bottom spacer(s) 160 are preferably positioned flush with the bottom of the box frame 120, or against the interior of the box bottom panel 125, to enable easy and consistent positioning of the top(s) of the bottom spacer(s) within the rack 100. The bottom spacers 160 may be oriented so that their smallest dimension (typically thickness) is oriented parallel to or perpendicular to the sides 121-124 of the box frame depending upon the desired spacing and thicknesses of materials. The bottom spacer(s) 160 may be manufactured by cutting a blank to form the spacer(s). The bottom spacer(s) 160 may be constructed from a cardboard or paperboard material. Examples of such materials include laminated paperboard, non-corrugated cardboard, and corrugated cardboard, manufactured from virgin or recycled materials. In a preferred exemplary construction, the bottom spacers 160 are cut from 1.9 mm greyboard to create a 3.8 mm cavity between the bottom of the tube locking layer 150 and the bottom of the box bottom panel 125 for suspension of the sample tubes above an underlying surface or scanning bed.

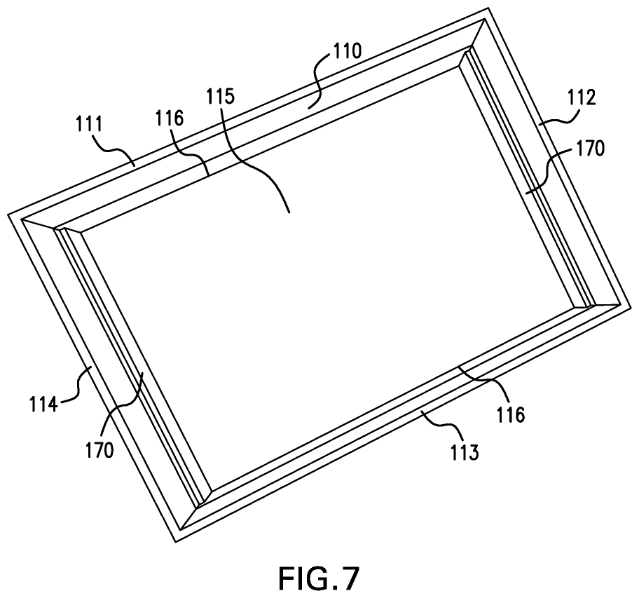

Turning to FIGS. 2-5, and in particular FIG. 7, in some of the same or other embodiments, a top spacer 170 may be affixed to the interior of the box lid 110 proximate the top 115 of the box lid, and configured to seat against a top surface of the box frame 120. In one construction, a top spacer 170 may, for example, comprise two strips of material affixed at opposite sides of the box lid 110. In alternate constructions, a top spacer 170 may comprise a plurality of inwardly projecting elements affixed to the inner surface of the box lid 110. In other alternate constructions, the top spacer 170 may comprise a square or rectangular panel positioned proximate the top 115 of the box lid 110 and having a central opening 172 which may align with and be substantially coextensive with the outermost ones of the matrix of open-ended apertures 142 of the tube holder layer 140. It will be appreciated that the top spacer(s) 170 may be affixed the interior of the sides 111-114 or top 115 of the box lid 110, or captured between the sides 111-114 of the box lid in an interference fit. The top spacer(s) 170 are preferably positioned flush with the interior surface of the top 115 of the box lid 110 to enable easy and consistent positioning of the bottom(s) of the top spacer(s) within the rack 100. The top spacers 170 may be oriented so that their smallest dimension (typically thickness) is oriented parallel to or perpendicular to the sides 111-114 of the box lid depending upon the desired spacing and thicknesses of materials. The top spacer(s) 170 may be manufactured by cutting a blank to form the spacer(s). The top spacer(s) 170 may be constructed from a cardboard or paperboard material. Examples of such materials include laminated paperboard, non-corrugated cardboard, and corrugated cardboard, manufactured from virgin or recycled materials. In a preferred exemplary construction, the top spacers 170 are cut from 1.9 mm greyboard so as to match the thickness of the sides 121-124 of the box frame 120. In such a construction, the width of the top spacers 170 may be set and, if necessary, changed (in order to accommodate taller or shorter sample tubes) so that the tops of sample tubes are spaced apart from the interior surface of the top 115 of the box lid 110 when the bottoms of the top spacers 170 are seated upon the top of the box frame 120.

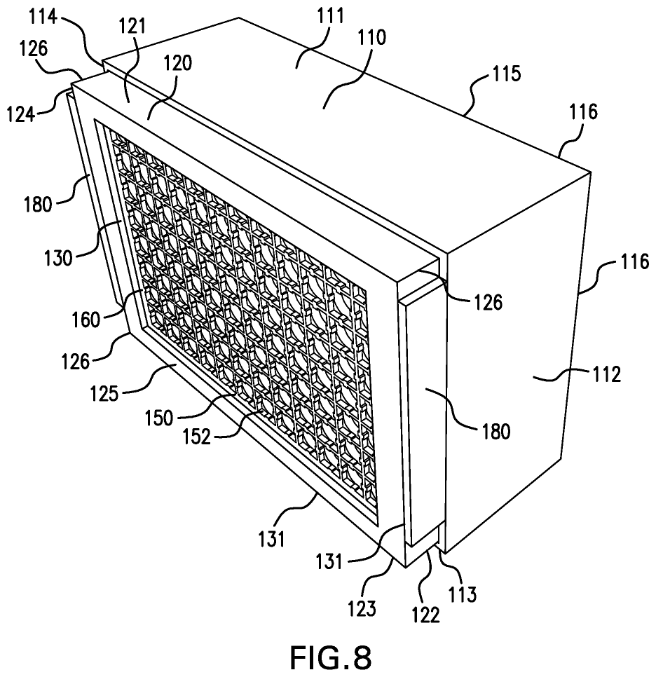

As further shown in FIG. 8, in some of the same or still other embodiments, an external flange 180 may be affixed to exterior of the box frame 120, and configured to block seating of the box lid 110 on the box frame beyond a predetermined depth. In one construction, an external flange 180 may, for example, comprise two strips of material affixed at opposite sides of the box frame 120. In alternate constructions, an external flange may comprise a plurality of outwardly projecting elements affixed to the exterior surface of the box frame 120. In other alternate constructions, an external flange 180 may comprise an elongated strip folded around and affixed to the perimeter of the box frame 120. It will be appreciated that the external flange 180 may be affixed the exterior of the sides 121-124 of the box lid frame 120 at any elevation above the bottom of the box frame. The external flange(s) 180 may be manufactured by cutting a blank to form the flange(s). The external flange(s) 180 may be constructed from a cardboard or paperboard material. Examples of such materials include laminated paperboard, non-corrugated cardboard, and corrugated cardboard, manufactured from virgin or recycled materials. In a preferred exemplary construction, the external flanges 180 are cut from 1.9 mm greyboard so as to match the thickness of the sides 111-114 of the box lid 110. In such a construction, the elevation and width of the external flange 180 may be set and, if necessary, changed (in order to accommodate taller or shorter sample tubes) so that the tops of sample tubes are spaced apart from the interior surface of the top 115 of the box lid 110 when the sides 111-114 of the box lid 110 are seated upon the top of the external flange 180.

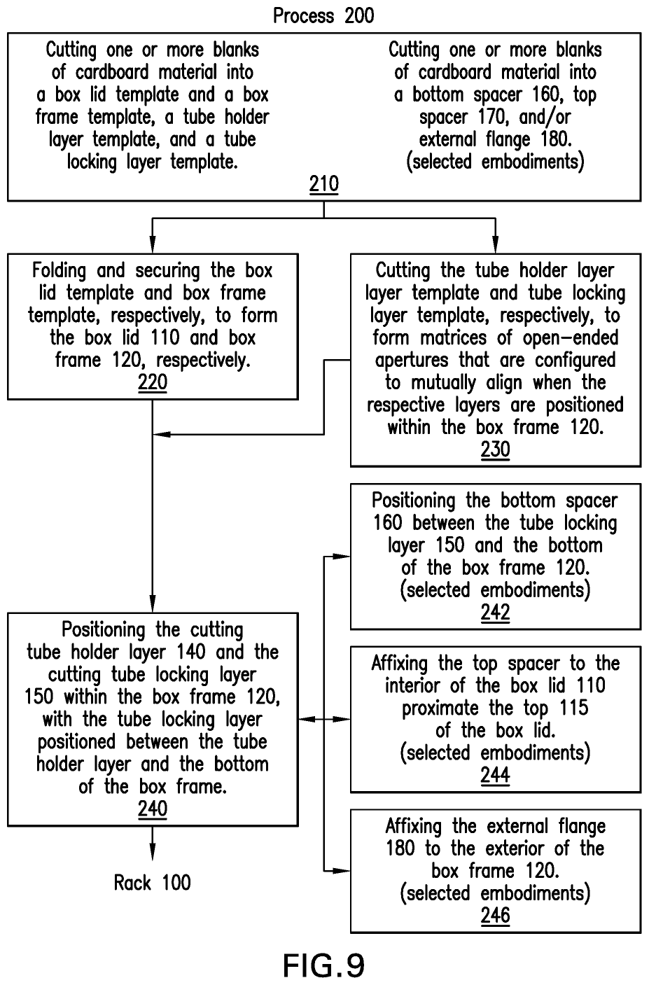

An example process 200 for manufacturing an example rack is outlined in FIG. 9. A cutting step 210 comprises cutting one or more blanks of cardboard material into a box lid template and a box frame template, a tube holder layer template, and a tube locking layer template. A folding step 220 comprises folding and securing the box lid template and box frame template, respectively, to form the box lid 110 and box frame 120, respectively. In various processes, the box lid 110 and box frame 120 may be secured in their respective folded shapes via adhesives, inside and/or outside corner tapes (including, for example, paper, cellulose, or polymer-backed adhesive tapes with or without fiberglass or other reinforcement), laminated overwraps (including, for example, adhered paper, cellulose, or polymer film overwraps with or without fiberglass or other reinforcement), or combinations thereof.

In some embodiments, a laser cutting step 230 comprises laser cutting the tube holder layer template and tube locking layer template, respectively, to form matrices of open-ended apertures that are configured to mutually align when the respective layers are positioned within the box frame 120. The laser cutting step may alternatively be accomplished through manual cutting techniques. A positioning step 240 comprises positioning the cut tube holder layer 140 and the cut tube locking layer 150 within the box frame 120, with the tube locking layer positioned between the tube holder layer and the bottom of the box frame. In some processes, the tube holder layer 140 and/or the tube locking layer 150 may be affixed after positioning to the interior of the sides 121-124 of the box frame 120 (and/or the optional box bottom panel 125) via adhesives, inside corner tapes (including, for example, paper, cellulose, or polymer-backed adhesive tapes with or without fiberglass or other reinforcement), or combinations thereof. In other processes, the tube holder layer 140 and/or the tube locking layer 150 may be captured between the sides 121-124 of the box frame 120 in an interference fit. In the same or still other processes, the tube locking layer 150 may be captured between the tube holder layer 140 and the box bottom panel 125. It will be appreciated that various combinations of affixation or capture, including affixation of the tube locking layer 150 to the tube holder layer without other affixation to the box frame 120, may be used in the process and that all potential combinations of affixation and/or capture are contemplated herein.

In some processes, the cutting step 210 includes cutting a bottom spacer 160, and an additional positioning step 242 includes positioning the bottom spacer between the tube locking layer 150 and the bottom of the box frame 120 (and/or the top of the optional box bottom panel 125). In the same or other processes, the cutting step 210 includes cutting a top spacer 170, and an additional positioning step 244 includes affixing the top spacer to the interior of the box lid 110 proximate the top 115 of the box lid, wherein the top spacer is positioned and configured to seat against a top surface of the box frame 120 upon assembly of the box lid to the box frame. In the same or still other processes, the cutting step 210 includes cutting an external flange 180, and an additional positioning step 246 includes affixing the flange to the exterior of the box frame 120, wherein the flange is positioned and configured to block seating of the box lid 110 on the box frame beyond a predetermined depth upon assembly of the box lid to the box frame. It will be appreciated that potential constructions of the bottom spacer 160, top spacer 170, and flange 180 and corresponding positioning, affixation, and/or capture steps have already been described above.

Advantageously, the programming or configuration of carboard and paperboard cutting and folding steps can be reconfigured to produce racks 100 having different footprints, different heights of sides 111-114 and 121-124, different size(s), shape(s), and number(s) of cut tube holder layer template(s) and cut tube locking layer template(s), and different size(s), shape(s), and number(s) of spacers 160, 170, 180 for inclusion in a specific embodiment or construction of the rack. In addition, a significant advantage of the laser cutting process is that the size, shape, number, and arrangement of the open ended apertures in the matrix of open-ended apertures 142 of the tube holder layer(s) 140, as well as the size, shape, number, and arrangement of the projections 154 may be changed simply by changing the laser cutting step 230 via programming of the laser cutter apparatus. Finally, the programming or configuration of the positioning steps 240, 242, 244, and 246 and any associated affixation or capture actions can readily be altered to produce racks 100 having different footprints, different heights of sides 111-114 and 121-124, different separations between the sample tubes and the bottom of the box frame 120 (and, where present, the box bottom panel 125), and different separations between the sample tubes and the top 115 of the box lid 110. In contrast to injection molded racks, the production of the rack 100 discloses herein may be changed over with retooling times of about 2 weeks, rather than 6-7 weeks. Furthermore, retooling of the production line during change-over may costs as little as $2,000, rather than $250,000 for a new set of injection molds.

It will be appreciated that the embodiments, constructions, and variations described above are cited by way of example, and that the present invention is not limited to what has been particularly shown and described hereinabove. Rather, the invention is considered to include both combinations and sub combinations of the various features described hereinabove, as well as variations and modifications thereof which would occur to persons skilled in the art upon reading the foregoing description and which are not disclosed in the prior art.

Numerous specific details are set forth herein to provide a thorough understanding of the claimed subject matter. However, those skilled in the art will understand that the claimed subject matter may be practiced without these specific details. In other instances, devices, structures, processes, methods, and systems that would be known to those one of ordinary skill have not been described in detail so as not to obscure the claimed subject matter.

The use of “configured to” herein is meant as open and inclusive language that does not foreclose devices and structures adapted to or configured to perform or provide additional functions. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modifications may be implemented by those skilled in the art without departing from the scope and spirit of the invention.

What is claimed is:

1. A rack for sample tubes, the rack comprising:
a. a box lid and a box frame;
b. at least one tube holder layer that has a matrix of open-ended apertures for receiving the sample tubes, wherein the at least one tube holder layer is constructed from a corrugated material; and
c. a tube locking layer that has a matrix of open-ended apertures, aligned with the matrix of open-ended apertures of the at least one tube holder layer, which each include one or more projections extending into the aperture for locking received sample tubes against rotation relative to the tube locking layer;
wherein the tube locking layer is positioned between the at least one tube holder layer and the bottom of the box frame.

2. The rack of claim 1 wherein the box frame has an open bottom.

3. The rack of claim 1 further comprising a bottom spacer, wherein the bottom spacer is positioned between the tube locking layer and the bottom of the box frame.

4. The rack of claim 1, further comprising a top spacer, wherein the top spacer is affixed to the interior of the box lid proximate the top of the box lid, and configured to seat against a top surface of the box frame.

5. The rack of claim 1, further comprising a flange, wherein the flange is affixed to the exterior of the box frame, and configured to block seating of the box lid on the box frame beyond a predetermined depth.

6. The rack of claim 1 wherein the rack is constructed from a cardboard material.

7. A process for manufacturing a rack, the process comprising the steps of:
cutting one or more blanks of cardboard material into a box lid template and a box frame template, a tube holder layer template, and a tube locking layer template;
folding and securing the box lid template and box frame template, respectively, to form a box lid and box frame;
cutting the tube holder layer template and tube locking layer template, respectively, to form matrices of open-ended apertures that are configured to mutually align when the respective layers are positioned within the box frame; and
positioning the cut tube holder layer and the cut tube locking layer within the box frame, with the tube locking layer positioned between the tube holder layer and the bottom of the box frame.

8. The process of claim 7, wherein the cutting step includes cutting a bottom spacer, and the positioning step includes positioning the bottom spacer between the tube locking layer and the bottom of the box frame.

9. The process of claim 7, wherein the cutting step includes cutting a top spacer, and an additional positioning step includes affixing the top spacer to the interior of the box lid proximate the top of the box lid, wherein the top spacer is positioned and configured to seat against a top surface of the box frame upon assembly of the box lid to the box frame.

10. The process of claim 7, wherein the cutting step includes cutting an external flange, and an additional positioning step includes affixing the flange to the exterior of the box frame, wherein the flange is positioned and configured to block seating of the box lid on the box frame beyond a predetermined depth upon assembly of the box lid to the box frame.

11. The process of claim 7, wherein the tube holder layer and tube locking layer are cut using laser cutting techniques.
